(19) United States
(12) Patent Application Publication
(10) Pub. No.: US 2008/0195507 A1
(43) Pub. Date: Aug. 14, 2008

(54) Virtual Online Store

(75) Inventor: Nitesh Ratnakar, Elkins, WV (US)

Correspondence Address: NITESH RATNAKAR, ROUTE 3,, BOX 179-A, ELKINS, WV, 26241, US

(73) Assignee: Nitesh Ratnakar, Elkins, WV (US)

(21) Appl. No.: 11/618,936

(22) Filed: Jan. 1, 2007

(51) Int. Cl. G06Q 30/00

(52) U.S. Cl. 705/27

(57) ABSTRACT

The present invention discloses means, methods and apparatus to create a virtual store with means to provide shoppers the look, feel and shopping experience of retail store. Virtual store replicates the external and internal layout of corresponding retail store in a virtual environment. The virtual store comprises of virtual isles, virtual shelves and virtual products that replicate the isles, shelves and products of corresponding retail store. The arrangement of the virtual isles, virtual shelves and virtual products in the virtual store is similar to the arrangement of the isles, shelves and products in the corresponding retail store. A virtual shopping cart is provided with means to move the virtual shopping cart from first position to second position in the virtual store. Means is provided for shoppers to virtually add virtual products to the virtual shopping cart. A payment gateway is integrated with the virtual store. Additionally, virtual store has integrated peer to peer networking applications providing means for shoppers to communicate live with other shoppers, store staff etc.

### FIELD OF INVENTION

The invention relates to online portal for retail stores; more specifically to means, methods and apparatus for creating a virtual store wherein shopping experience is similar to that when shopping in retail store.

### PRIOR ART AND BACKGROUND

It is a common practice for retailers to have an online store where shoppers can browse and purchase products from the comfort of their homes. Presently online store contains an inventory of products, shopping cart and a payment gateway. Online stores usually contain pictures and information about products. A search engine is usually built in to enable shopper easily find products. Shopping cart is provided to enable shoppers to gather products they wish to buy. A payment gateway is provided to enable shoppers pay online for products. Over the last decade, online stores have grown at a phenomenal rate and most retailers now have online presence. Shopping on online retail stores account for billions of dollars in annual sales, and has become an integral part of retail business strategy. However in spite of the phenomenal growth and popularity of online stores, majority of retail business is still done at retail stores in the conventional way where shoppers visit retail stores, browse through product inventory and buy products they like. There are many possible reasons for this. The current format and structure of online stores does not provide the look and feel of corresponding retail store. Many shoppers enjoy the ambience, look and feel of retail stores. The experience of browsing through the isles of retail outlet is dear to many shoppers. Currently, online stores do not have the ambience, look and feel of retail stores and consequently deprive shoppers of shopping experience of retail stores. Shopping is a social experience for many shoppers. It gives then a chance to meet new people while shopping. Many shoppers prefer to go shopping with family and friends, in which case shopping gives then a chance to spend time with loved ones. It also enables then to share information and experiences about products, sales, bargains etc. with family, friends and co shoppers. Presently, online stores do not give shoppers means to communicate with peers. Consequently, shoppers shop online without any help from family and friends. Present online stores deprive shoppers of the social aspect of shopping.

Aim:

There remains a need for an online store that provides shopping experience that is comparable to retail store. Accordingly, the aim of the invention is to provide methods, means, apparatus and system to create online store—the ‘virtual store’, that provides ambience, look, feel and shopping experience that is as comparable to the ambience, look, feel and shopping experience of corresponding retail store.

### SUMMARY

The present invention discloses means, methods and apparatus to create a virtual store with means to provide shoppers the look, feel and shopping experience of retail store. Virtual store replicates the external and internal layout of corresponding retail store in a virtual environment. The virtual store comprises of virtual isles, virtual shelves and virtual products that replicate the isles, shelves and products of corresponding retail store. The arrangement of the virtual isles, virtual shelves and virtual products in the virtual store is similar to the arrangement of the isles, shelves and products in the corresponding retail store. A virtual shopping cart is provided with means to move the virtual shopping cart from first position to second position in the virtual store. Means is provided for shoppers to virtually add virtual products to the virtual shopping cart. A payment gateway is integrated with the virtual store. Additionally, virtual store has integrated peer to peer networking applications providing means for shoppers to communicate live with other shoppers, store staff etc.

### DETAILED DESCRIPTION OF INVENTION

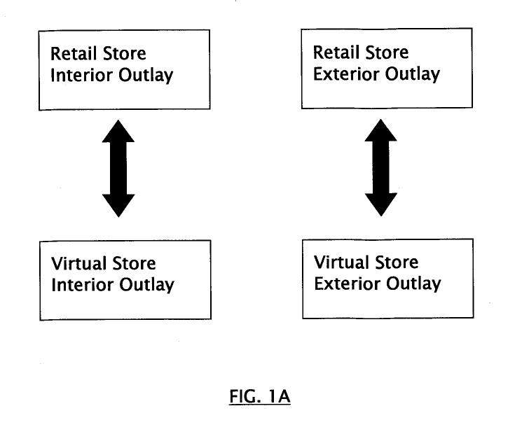

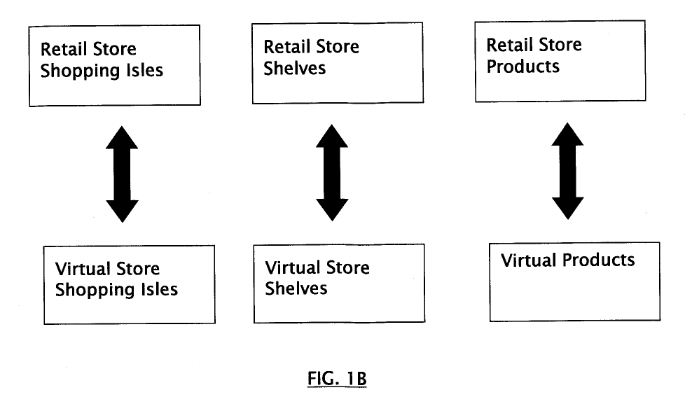

The present invention presents the next generation online store; the ‘virtual store’. Virtual store replicates features of corresponding retail store in a virtual environment. In order to create a simulation of retail store in a virtual environment, a detailed simulation of each component of the retail store is done. This is accomplished in the following steps. Store Mapping (FIG. 1A): In this process the general layout of retail store is replicated in a virtual environment. Parameters replicated in this step includes exterior and interior layout of the store including entrances and exits, external and internal color schemes, flooring, lighting, ambient noise, check out, customer service and any other relevant feature related to the layout of corresponding retail store. Isle & Shelf Mapping (FIG. 1B): In this step the isles and shelves of retail store are replicated in a virtual environment. The virtual isles and virtual shelves in the virtual store are arranged similar to the isles and shelves in the corresponding retail store. The virtual isles are labeled similar to their labeling in the corresponding retail store. Product Mapping (FIG. 1B): In this step, each product in the inventory of the corresponding retail store is replicated in a virtual environment. Preferably the inventory of the virtual store is similar to that of the corresponding retail store. Product packaging is also replicated in virtual environment. Preferably means is provided in the virtual store to virtually unpack/open virtual products, as is possible with products in retail stores. Placement of virtual products in the virtual store is similar to placement of corresponding products in the corresponding retail store. This helps shoppers find products easily in virtual store as shoppers are usually familiar with product placement in corresponding retail store. Product information is displayed, either along side each product or by means of link. When a product is added to the inventory of virtual store, detailed information about said product is entered into the inventory database. Said product information may comprise of text, voice, images, graphics, video or a combination thereof. Shopping Cart: A virtual shopping cart is provided to enable shoppers gather products they wish to purchase. Means is provided to move virtual shopping cart from first position to the second position in the virtual store. Preferably this is done using mouse or by other means such as a joystick. Means is provided for shoppers to virtually pick products from virtual shelves and move them into the virtual shopping cart. Means is provided to display products contained in the virtual shopping cart. Means is also provided for shoppers to move products from the virtual shopping cart to virtual shelves should shopper decide to return one or more products. Means is provided to total the charges for products contained in the virtual shopping cart. A payment gateway is integrated to enable shoppers to pay for the products they purchase.

Codes for the virtual store can be written in a regular code editor, however for optimal configuration and performance, preferably it is written in an Integrated Development Environment (IDE). Preferably IDE would consist of a combination of one or more of; source code editor, a compiler and/or interpreter, build-automation tools, a debugger, a version control system and tools to simplify the construction of a GUI. Many modern IDE also integrate a class browser, an object inspector and a class hierarchy diagram, for use with object oriented software development. IDE can be a multiple-language IDE such as the Eclipse IDE, NetBeans, Microsoft Visual Studio and the like or it can be devoted to a specific programming language, as in the Visual Basic IDE. Examples of present IDE's that can be used to write codes for virtual store include ‘Code Warrior’ and ‘Microsoft Visual Studio’ for Windows and ‘X code’ for Macintosh. The programming language most suitable at present is Java and C/C++. Custom tools can be developed in house based on individual needs of clients. Graphics and real time rendering will be important to successful development of virtual store. A number of powerful 3D modeling programs exist presently that will be useful in developing virtual store. Some common modeling programs which can be used are ‘Maya’, ‘3D Studio Max’ and ‘Adobe Photoshop’. It is important to remember that these are not the only tools and programs that can be used for graphics development, although they are the most common. The discussion of integrated development environment, programming language and 3D modeling programs is for illustration purposes only and should not be considered limiting in anyway as many options exist presently, and many more will be created in the future, which may be useful in creating the virtual store.

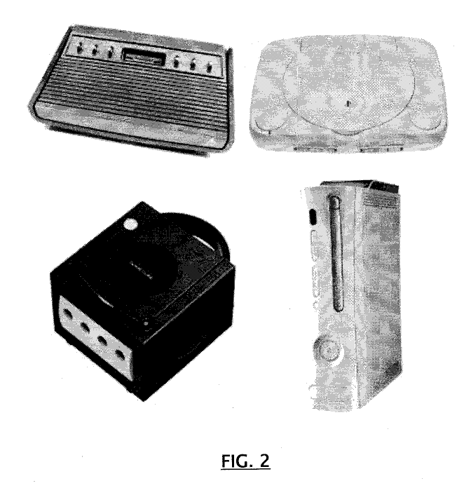

The virtual store contain vast amount of data in view of the extensive features and large inventory database. According to one preferred method, the software, applications and inventory data of the virtual store is stored into a storage media such as CD-ROM/DVD and the like. The said storage media is distributed to shoppers to be installed on their personal computers. Once installed, the software, applications and inventory database contained in the virtual store is thereafter updated in a web based environment. This method a) consumes less bandwidth b) increases the speed with which shoppers can browse and shop products in the virtual store c) makes the process of keeping the inventory current easy d) enables seamless and efficient management of vast amount of data. With the rapid deployment and advancement of broadband internet access; operation of the virtual store can be done on a wide scale in an internet based environment. Installation and operation of the virtual store can also be done on machines other than personal computers such as video game consoles. In this method, the virtual store is installed and operated on dedicated console—‘virtual store console’; similar to video game consoles such as Sony PlayStation, Microsoft X-box, Nintendo and the like (FIG. 2). The virtual store console comprises of a 1) user control interface; 2) central processing unit (CPU); 3) RAM; 4) software kernel/operating system; 5) storage medium; 6) video output; 7) audio output; 8) modem/network; and 9) power supply. Preferably, the virtual store console has a dedicated graphics processor with means to provide specialized mapping, texturing, geometric functions and control video output. The video output signal is preferably compatible with television such as NTSC, PAL, SECAM and the like. The virtual store is pre loaded into virtual store console or is saved on a storage media such as CD ROM/DVD and the like and then uploaded and run on virtual store console. The virtual store console is connected to the internet. The software, features, applications and inventory data of the virtual store on the virtual store console is updated in a web based environment. Preferably this happens automatically at pre determined intervals.

Virtual store of present invention also has unique peer to peer networking and communications features. Chat, video and VOIP (voice over internet protocol) applications are integrated into the virtual store. Means is provided for shoppers to connect and communicate with a live sales associate via the peer to peer networking applications. This feature will enhance the shopper's experience and satisfaction. This is in contrast to present shopping experience in retail stores where shoppers usually have to wait for long periods before help from a sales associate is obtained. Virtual store has means to make virtual shopping a social experience similar to shopping in retail store. The integrated chat, video and VOIP applications enable peer to peer networking among various shoppers. Means is provided shoppers to attach a picture or unique replicas of self (avatars) to their shopping cart to enable other shoppers in the virtual store identify them. Shoppers can make a personalized buddy list by adding shoppers they would like to shop with. Whenever a contact from buddy list is shopping in the virtual store at the same time as the shopper, an alert is generated and shopper has means to invite said contact to shop with him/her. Additionally, a peer search engine is provided for shoppers to find other shoppers according to pre determined filters. For example a shopper can find other shoppers shopping in same isle, or find shoppers who are looking at the same product and other similar filters. Shopper can then communicate with selected shoppers using the peer to peer networking applications of the virtual store.

Customer review is an important element of research about products. Presently, shoppers have limited means to obtain customer review when shopping in retail stores. Customer review is currently obtained by word of mouth from family and friends or sometimes via traditional public media. Virtual store of present invention provides an effective way for shoppers to obtain and view customer reviews of a product. Means is provided in the virtual store for shopper to post review about products. Preferably customer reviews are displayed along side product information. Means is provide for shopper to sort customer reviews according to desired filters. For example, a shopper may want to view reviews only from customers in his location, or only from customers who have purchased a product within 2 years etc. Means is also provided in the virtual store for shoppers to communicate with one or more reviewers using the peer to peer networking applications of the virtual store to obtain their feedback regarding a product. These means of communications between shoppers significantly enhances the shopping experience of virtual store and enable shoppers to make well-informed and wise shopping decisions. The peer to peer networking applications of the virtual store can also be used by storeowners to communicate and network with shoppers. For example, store owners can announce a product sale which is played/displayed on the personal computer/virtual store console of active shoppers using the peer to peer networking applications of the virtual store.

What is claimed is:

1. A virtual store comprising of virtual lay out of retail store.

2. The virtual store of claim 1 wherein the exterior layout of the virtual store is similar to corresponding retail store.

3. The virtual store of claim 1 wherein the interior layout of the virtual store is similar to the corresponding retail store.

4. The virtual store of claim 3 wherein the interior layout of the virtual store comprises of one or more virtual isles.

5. The virtual store of claim 4 wherein the interior layout of the virtual store comprises of one or more virtual shelves placed along the virtual isles.

6. The virtual store of claim 5 wherein the interior layout of the virtual store comprises of one or more virtual products placed on the virtual shelves.

7. The virtual store of claim 6 wherein the arrangement of virtual products in the virtual store is similar to the arrangement of products in the corresponding retail store.

8. The virtual store of claim 6 wherein the placement of virtual products in the virtual store is similar to the placement of products in the corresponding retail store.

9. A virtual store comprising of one or more virtual products.

10. The virtual store of claim 9 wherein the arrangement of virtual products in the virtual store is similar to the arrangement of products in the corresponding retail store.

11. The virtual store of claim 9 wherein the placement of virtual products in the virtual store is similar to the placement of products in the corresponding retail store.

12. The virtual store of claim 9 wherein means is provided for customers to view information about virtual products.

13. The virtual store of claim 9 wherein means is provided for customers to post review about virtual products displayed on the virtual store.

14. The virtual store of claim 9 wherein means is provided for customers to view reviews about virtual products.

15. A virtual store comprising of a virtual shopping cart.

16. The virtual store of claim 15 wherein the virtual shopping cart is similar to the shopping cart in corresponding retail store.

17. The virtual store of claim 15 wherein means is provided to virtually move the virtual shopping cart from a first position to a second position in the virtual store.

18. The virtual store of claim 15 wherein means is provided to add one or more products displayed in the virtual store to virtual shopping cart.

19. The virtual store of claim 15 wherein means is provided to calculate the total charges of products in the virtual shopping cart.

20. The virtual store of claim 15 wherein a payment gateway is integrated.
